(19) United States
(12) Patent Application Publication
(10) Pub. No.: US 2022/0000319 A1
(43) Pub. Date: Jan. 6, 2022

(54) SHOWER-SCREEN RETRACTION SYSTEM

(71) Applicant: SHOWER SHIELD LIMITED, Wales (GB)

(72) Inventor: David Rauch, London (GB)

(21) Appl. No.: 17/290,752

(22) PCT Filed: Nov. 15, 2019
(86) PCT No.: PCT/GB2019/053252

§ 371 Date: Apr. 30, 2021

(30) Foreign Application Priority Data
Nov. 16, 2018 (GB) 1818757.5

(51) Int. Cl. A47K 3/34

(52) U.S. Cl. CPC A47K 3/34; E06B 2009/801

(57) ABSTRACT

A shower-screen retraction system (10) for providing a temporary, self-retracting and self-cleaning barrier for a bath or a shower, comprises a screen-mounting support member (12) having a biasing means (26) and a housing (19). A screen (16) has a first screen end (62a), associated with the screen-mounting support member (12), and a second screen and (62b) opposite to the first screen end (62a). The housing (19) is an irregular polygon in cross-section into accomodate a screen-wiper (46) whilst optimising an internal volume to avoid impingement of the screen (16) once furled.

The present invention relates to a shower-screen retraction system for use in a shower and/or a bath. The present invention also relates to a method of providing a shower-screen retraction system for use in a shower or a bath.

Showering in a bath tub or in a shower basin without an appropriate barrier to contain water may result in inundating the floor with water in the immediate vicinity of the shower or bath tub. In addition to the potential damage, this spillage creates a slipping hazard. A solution is to provide a shower curtain or a door. However, a hinged or slidable door may not be practical due to spatial limitations and requires effort to keep clean. Installation costs may also be prohibitive. A slidable door further requires a guiding rail or rails which, in addition to potentially being visually unsightly, can be difficult to clean. A curtain is usually cheaper, can be gathered to minimise space taken up, does not usually require cleaning and is easier to replace than a door. However, a curtain also requires a rail and both the curtain and the rail may be unsightly. Furthermore, a curtain may drip water outside of the bath if it is badly positioned.

The present invention seeks to provide a solution to these problems.

According to a first aspect of the invention, there is provided a shower-screen retraction system for providing a temporary, self-retracting and self-cleaning barrier for a bath or a shower, comprising: a screen-mounting support member having a biasing means and a housing, a screen having a first screen end, associated with the screen-mounting support member and/or the biasing means, and a second screen end, opposite the first screen end; and, also preferably, at least one screen-contacting wiper for removing water on the screen, such that during retraction of the screen into the screen-mounting support member by the biasing means, the screen slides against the said screen-contacting wiper to self-clean. This shower-screen retraction system provides a waterproof barrier to prevent or inhibit water from inundating the floor in the immediate vicinity of the shower or bath. The shower-screen retraction system is compact and appropriate for tight spaces where a door may not be appropriate. Due to the self-retracting properties and the preferable beneficial omission of rails, the shower-screen retraction system can be self-cleaning, discreet and out of sight when not in use. Crucially, the shape of the housing allows for a cleaning mechanism to be internal and out of sight without impeding the biasing mechanism and without the housing being larger than required.

Optionally, the housing may be a trapezium in cross-section. However, other circular or non-circular shapes of housing may be considered. A primary advantage of the preferred trapezium cross-section, having two parallel sides and at least one non-perpendicular angle is the optimisation of space to enable accommodation of the hidden internal wiper. To this end, the housing may have at least one non-perpendicular, preferably interior, angle. For example, although a lateral cross-section of the housing may be circular, a diameter is required to be oversized to accommodate the wiper without impinging on the screen once furled.

The shower-screen retraction system may further comprise a further support member associated with the second screen end. Said further support member may be mateably engageable with the screen-mounting support member. Furthermore, the screen-mounting support member and the further support member may be mateably engageable in a first plane; the screen defining a second plane when in an extended condition, and the first plane and the second plane are non-perpendicular to one another. These features improve the compactness and the sightliness of the framework and prevent or inhibit lateral movement of the further support member relative to the screen-mounting support member when mateably engaged.

Advantageously, the said further support member may comprise a handle element for providing a means to grasp the screen from within or outside of the shower or bath when in a retracted condition or when in the extended condition. Furthermore, the further support member may have an ergonomic surface for increasing the ease of grasping for a user. Additionally, the ergonomic surface may comprise a high grip surface and/or at least one gripping rib. These features allow a user to more easily grasp the screen and/or further support member, from both within and without the shower.

Preferably, the shower-screen retraction system, further comprises a cover connectable to the housing, the cover having an open condition and a closed condition. Beneficially, the cover may comprise a hinge such that the cover is hingeably connectable to the housing.

Optionally, the cover may further comprise at least one cover-closure element for retaining the cover in the closed condition. Furthermore, when the screen is in a retracted condition, the further support member may be abutted against the screen-mounting support member, and when the cover is in the closed condition, the cover may surround the at least one screen-contacting wiper and/or the further support member. Preferably, when the cover is in the closed condition, the cover further surrounds the handle element. The cover, particularly in the closed condition, visually hides preferably both the wiper and further support member, including the handle element, from view, further improving the sightliness of the shower-screen retraction system. The hinge improves the ease of use whist the cover-closure element prevents or inhibits the cover from accidentally being operated into the open condition.

The screen-mounting support member and the further support member may be mateably engageable in a first plane; the screen defining a second plane when in the extended condition, and the first plane and the second plane may be non-perpendicular to one another. The first and second planes being at a non-perpendicular angle help the user grasp the handle as well as helping the screen-mounting support member and the further support member mateably engage by preventing lateral motion. Furthermore, the further support member hides at least in part the screen-clasping element from sight, improving the aesthetics of the shower-screen retraction system.

Optionally, at least one of the screen-mounting support member and the further support member may have at least one sealing element such that, when in the retracted condition, the further support member may be mateably engaged with the screen-mounting support member so that the sealing element may form a seal. The sealing element allows the drainage channel to be closed off entirely, should the shower-screen retraction system be installed in a reverse orientation. Furthermore, the sealing element introduces a gap between the screen-mounting support member and the further support member such that water may dry and reduce rust formation or rotting. The seal limits the damage caused by rubbing and wear-and-tear where the screen-mounting support member contacts the further support member.

At least one of the screen-mounting support member and the further support member may conveniently be formed by extrusion. This simplifies the manufacturing process as well as reducing or inhibiting the formation of rust at junctions.

Optionally, the shower-screen retraction system may further comprise a connector having a first connector part and a second connector part, and at least one of the first connector part and the second connector part may be connectable on or adjacent to the second screen end and/or the further support member. Additionally, the other of the first connector part and the second connector part may be fastenable to a wall via a fastening means. Furthermore, the fastening means may comprise a fastener which may comprise at least one of a screw, a bolt, and glue. Additionally, the first connector part may be at least one latch and the second connector part may be a lock, or vice-versa, such that the at least one latch may be engageable with the lock. Having a two-part connector provides further stability compared to having a single-part connector and individual components are more easily replaceable without having to change the whole shower-screen retraction system. Furthermore, there may be a plurality of second connector parts with which the first connector part may be engageable with, such that the size of the shower cubicles may be selectable. The system is also suitable for showers having unconventional dimensions. Alternatively, the connector may comprise at least one of: a hook-and-eye system; mateably-engageable protrusions; and at least one suction cup. A redundancy of systems provides further stability and/or customisability.

Additionally, the connector may have an actuatable component, for locking or unlocking the securing of the screen when in the extended condition. Optionally, the actuatable component may be a button. Having an actuatable component reduces the risk of the first and second connector parts becoming accidentally disengaged. Additionally, having an actuatable component such as a button may be considered as being more refined, sophisticated and aesthetically pleasing than merely opening the connector manually and/or it may be easier for users with limited strength.

Preferably, the shower-screen retraction system comprises a connector having a first connector part and a second connector part engageable with the first connector part, and the second connector part is connectable to a wall via a connector-fastener. Advantageously, the second connector part may comprise a hook element. Furthermore, the first connector part may be associated with the second screen end. Additionally, the first connector part may comprise the said handle element. The handle element being also the first connector part simplifies the manufacture and ease of use.

Optionally, the screen may be pliable and/or comprise a plurality of slats and/or have antimicrobial properties. Additionally, the biasing means may be a spring-loaded roller, such that the screen may be wrappable around the spring-loaded roller. These features allow the screen to be actuatable into an extended or taut condition or into a retracted or compact condition as well as increasing the cleanliness.

Furthermore, the screen and/or biasing means may be slideably insertable into the housing via an open end thereof. The ease of assembly and replaceability is increased.

Preferably, the housing comprises a plurality of aeration apertures and/or a mesh. Aeration, and therefore drying of the screen is improved.

Advantageously, the screen-mounting support member may have at least one internal screen-contacting wiper for removing any water on the screen, such that when the screen is biased towards the screen-mounting support member by the biasing means, the screen may be slidably moveable against the said screen-contacting wiper for providing a self-cleaning screen. The advantage of this feature is that the screen is self-cleaning, thereby reducing the amount of effort, water, and time spent by a user to clean the screen. The shelf-life of the screen is also prolonged, such that it does not need to be replaced as often, thereby also reducing costs for the user.

Preferably, the screen-mounting support member is slideably engageable with a wall-mountable fastener such that the screen-mounting support member is slidably removable relative to a further wall. Furthermore, the shower-screen retraction system may further comprise a wall fixing element, wherein the wall fixing element may be engageable with the screen-mounting support member to provide a two-part system, said two-part system being slideably engageable with the wall-mountable fastener such that the screen-mounting support member and/or the wall fixing element may be slidably removable. The ease of assembly and disassembly is increased.

Additionally, the shower-screen retraction system may further comprise a wall fixing plate, which may alternatively be referred to as a wall fixing element, wherein the screen-mounting support member may be fastenable to a further wall via the said wall fixing plate. Furthermore, the screen-mounting support member and/or the wall fixing plate may be fastenable to the said further wall at least one of a screw, a bolt, an adhesive or a magnet. Modularity allows the screen-mounting support member to be removable and easily replaceable without having to dismantle the wall fixing plate and potentially drilling more holes into the wall than strictly necessary.

Furthermore, the shower-screen retraction system may comprise a wall fixing element, wherein the wall fixing element may be positionable between the housing and a further wall. The wall fixing element may provide a protective buffer between tiles and the metallic housing.

Beneficially, the housing and/or the wall fixing element may be removably fastenable to the said further wall via a fastener. Additionally, the second connector part may be slideably removably connectable to the wall via the connector-fastener. The fasteners enable the screen-mounting support member and/or the second connector part to be easily removable, without needing to remove the fastener.

Optionally, the wall-mountable fastener and/or the connector-fastener may comprise at least one protrusion such that the wall-mountable fastener and/or the connector-fastener may be or may be substantially L-shaped.

Additionally, the wall-mountable fastener and/or the connector-fastener may comprise a further protrusion such that the wall-mountable fastener and/or the connector-fastener may be or be substantially U-shaped. Furthermore, the wall fixing element and/or the screen-mounting support member may comprise a recessed portion having a depth equal to or greater than a width of the further said protrusion for enabling the screen-mounting support member and/or the wall fixing element to be or substantially be flushly abuttable against the further wall.

Additionally, the or at least one of the said wall-mountable fasteners may comprise a further protrusion such that the or at least one wall-mountable fastener may be or be substantially U-shaped. Furthermore, the wall fixing element and/or the screen-mounting support member may further comprise a recessed portion having a depth equal to or greater than a width of the further said protrusion for enabling the screen-mounting support member and/or the wall fixing element to be or substantially be flushly abuttable against the further wall. The fastener inhibits or prevents movement of the screen-mounting support member relative to the wall. Furthermore, the U-shaped fastener enables the screen-mounting support member to be held or held substantially vertically when engaged with the fastener, even if the wall is not necessarily planar.

Beneficially, the screen-mounting support member may comprise a drainage channel for channelling water towards the shower or bath. Additionally, the screen may further comprise a bottom screen edge, and the shower-screen retraction system may further comprise a further sealing element, positioned at or adjacent to the bottom screen edge for channelling water running down the screen towards the shower or bath when the screen is in the extended condition. These features reduce the likelihood of spillage outside of the bath tub.

According to a second aspect of the invention, there is provided a method of installing a shower-screen retraction system, the method comprising the steps of: a] providing a shower-screen retraction system having a wall-mountable sliding assembly and a locking assembly; b] slideably engaging the wall-mountable sliding assembly with a first wall directly and/or indirectly via a wall fixing element and/or a fastening means; c] engaging at least part of the locking assembly to a second wall via a further fastening means.

According to a further aspect of the invention, there is provided a shower-screen retraction framework comprising: a screen-mounting support member and a further support member, the screen-mounting support member and the further support member being vertical or substantially vertical; and no other support member, such that the shower-screen retraction framework is railless. Having no horizontal rails means there are no or fewer corners and slits to clean which are difficult to access. The framework is more discreet and thus more sightly than a conventional shower cubicle having rails.

According to a further aspect of the invention, there is provided a method installing a shower-screen retraction system, comprising the steps of: a] providing a shower-screen retraction system having a wall-mountable sliding assembly and a locking assembly; b] fastening the wall-mountable sliding assembly to a first wall directly and/or indirectly via a wall fixing plate and a fastener; c] fastening at least part of the locking assembly to a second wall via a fastening means, said fastening means including at least one screw. The advantage is the modularity and customisability provided by the ability to engage and disengage a wall-mountable sliding assembly from the fixing plate. The wall fixing plate also allows the weight of the wall-mountable sliding assembly to be distributed more evenly. Additionally, a screw may provide further strength than adhesive double-sided tape.

According to a further aspect of the invention, there is provided a shower-screen retraction system comprising a wall-mountable sliding assembly and a fixed locking assembly. This provides a framework which is more compact, discreet and thus more sightly than a conventional shower cubicle.

According to a further aspect, there is provided a shower-screen retraction system for providing a temporary, self-retracting and self-cleaning barrier for a bath or a shower, comprising: a screen-mounting support member having a biasing means, a screen having a first screen end, associated with the screen-mounting support member and/or the biasing means, and a second screen end, opposite the first screen end; a connector, positioned at or adjacent to at least the second screen end, the connector for securing the second screen end to be spaced-apart from the screen-mounting support member, and characterised in that, in-use, the screen has a retracted condition and an extended condition, wherein in the retracted condition, the biasing means biases the screen to be at least partly retracted with regards to the screen-mounting support member, and wherein in the extended condition, the connector is adapted to secure the second screen end to be spaced-apart from the screen-mounting support member to counteract the biasing means, and the biasing means biases the screen towards the screen-mounting support member such that the screen forms a planar or substantially planar barrier between the screen-mounting support member and the connector.

The invention will now be more particularly described, with reference to the accompanying drawings, in which:

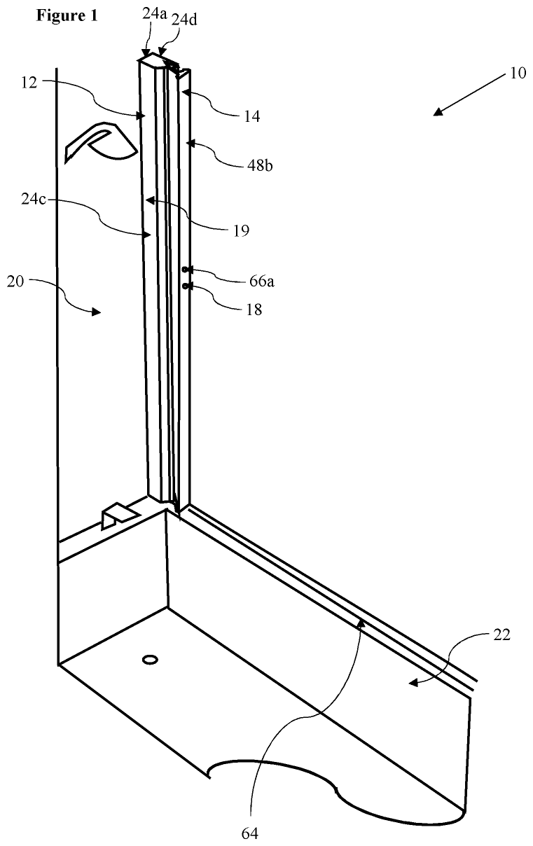

FIG. 1 shows a perspective representation of a first embodiment of a shower-screen retraction system in accordance with the first aspect of the invention, in a retracted condition with the second connector part and a second wall omitted for clarity;

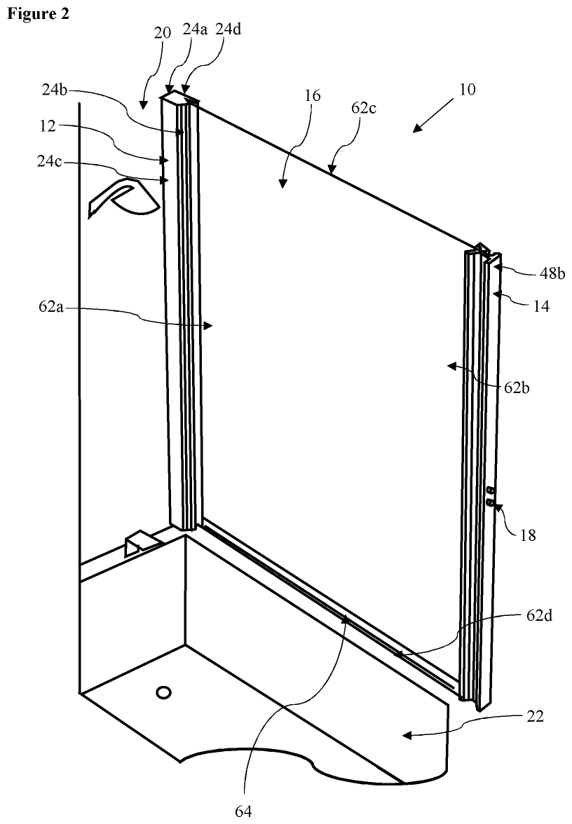

FIG. 2 shows the shower-screen retraction system shown in FIG. 1, in an extended condition with the second connector part omitted for clarity;

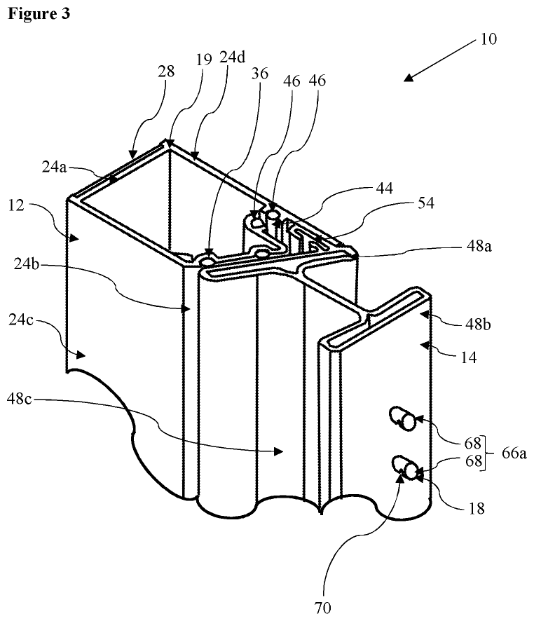

FIG. 3 shows a close-up perspective representation of the shower-screen retraction system of FIG. 1, with the biasing means and the screen omitted for clarity;

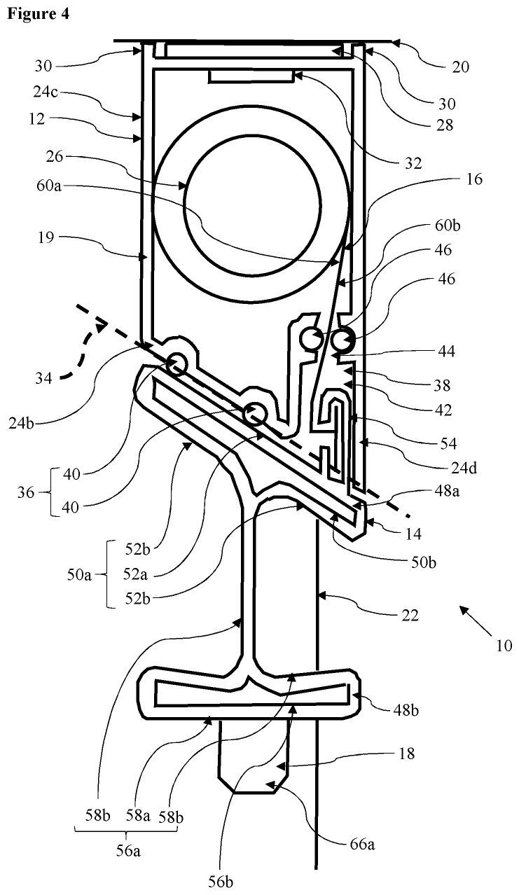

FIG. 4 shows a top-down cross-sectional representation of the shower-screen retraction system of FIG. 1;

FIG. 5 shows an exploded perspective representation of one embodiment of a second connector part for a shower-screen retraction system in accordance with the first aspect of the invention;

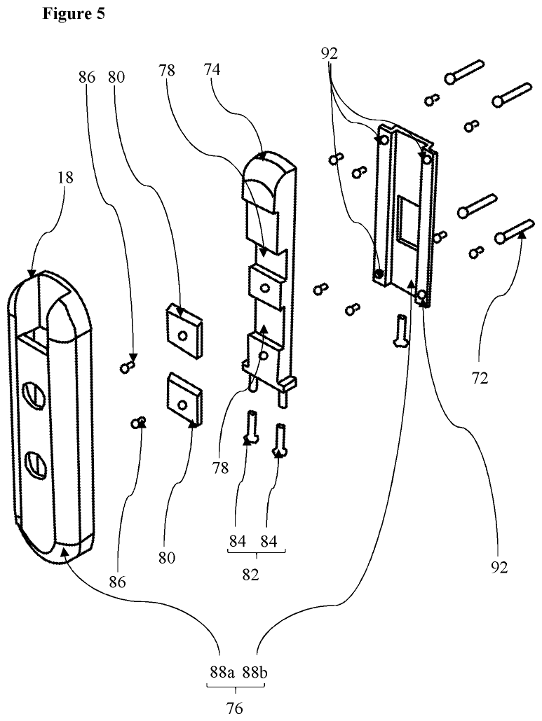

FIG. 6 shows a perspective representation of the second connector part of FIG. 5, in a locked condition; and

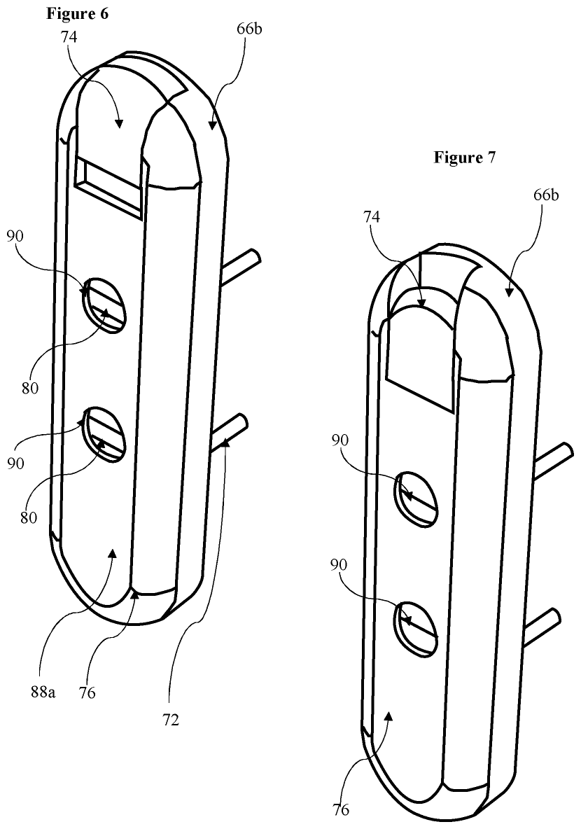

FIG. 7 shows a perspective representation of the second connector part of FIG. 5, in an unlocked condition;

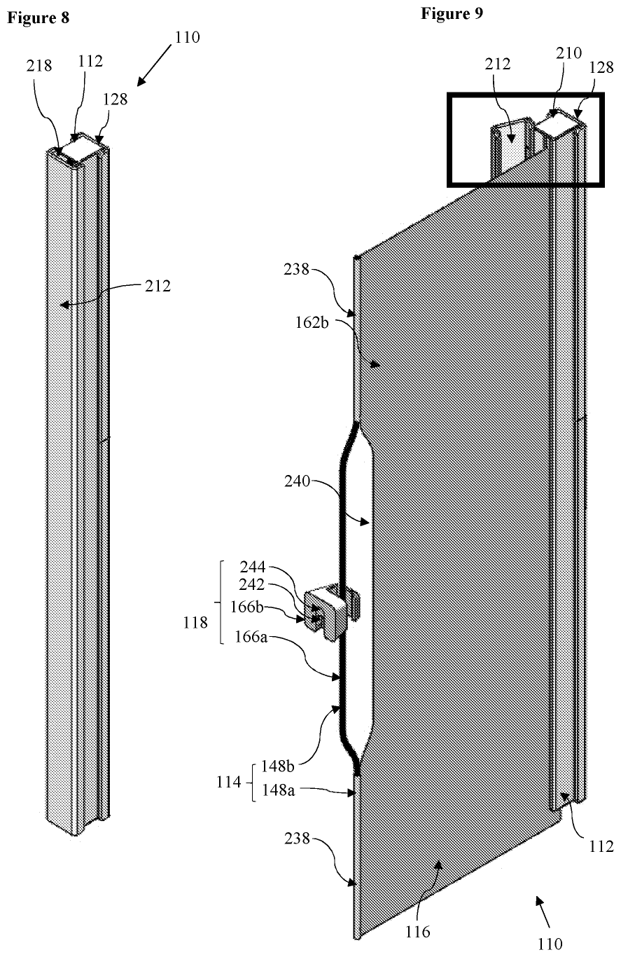

FIG. 8 shows a front perspective representation of a second embodiment of a shower-screen retraction system in accordance with the first aspect of the invention, in a closed condition, with the second connector part omitted for clarity;

FIG. 9 shows the shower-screen retraction system of FIG. 8, in an open condition, with a second connector part shown but the second wall omitted for clarity;

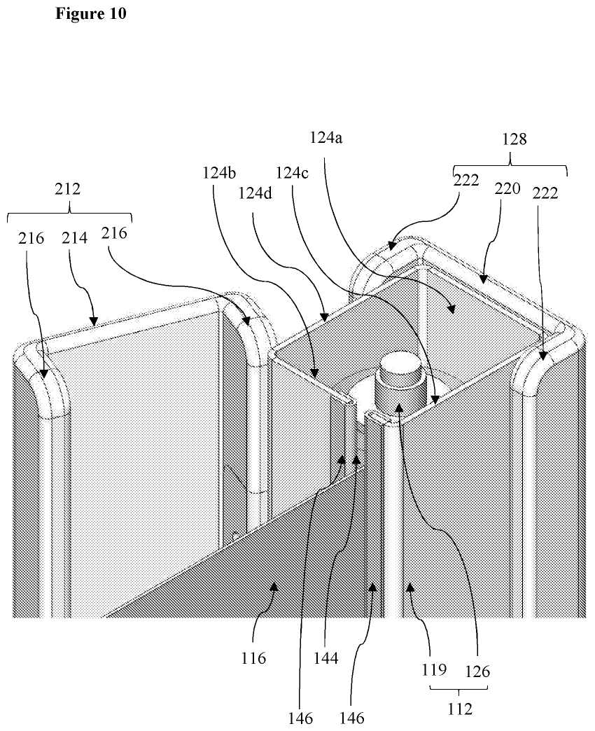

FIG. 10 shows a close-up of the rectangle of FIG. 9;

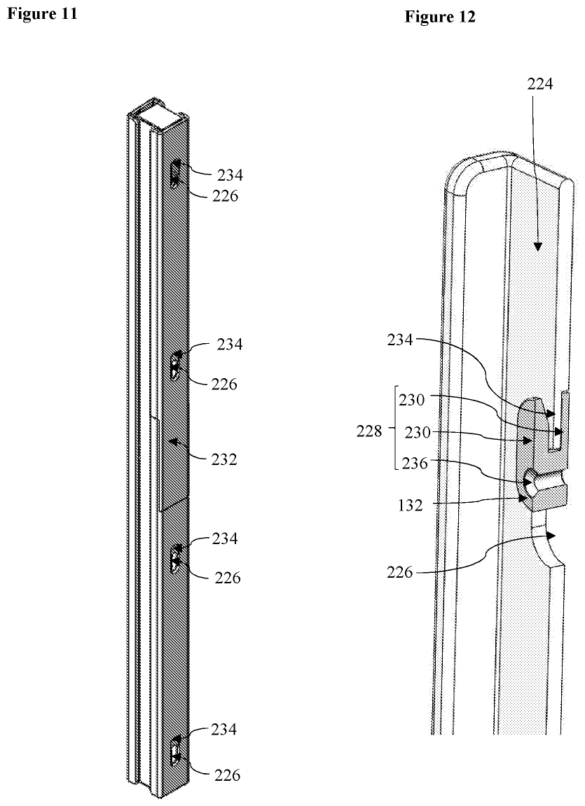

FIG. 11 shows a back perspective representation of the shower-screen retraction system of FIG. 8;

FIG. 12 shows a partial cut-away perspective view of a wall fixing element and a fastener of the shower-screen retraction system of FIG. 8, with the housing omitted for clarity.

Firstly referring to FIG. 1, there is provided a shower-screen retraction system indicated generally at 10 for providing a temporary, self-retracting and self-cleaning barrier for a bath or a shower, comprising a wall-mountable sliding assembly and a locking assembly.

The wall-mountable sliding assembly comprises a screen-mounting support member 12, a further support member 14 and, as shown in FIG. 2, a screen 16 extendable therebetween. The locking assembly comprises a connector 18 which is capable of securing the further support member 14 in a spaced-apart condition from the screen-mounting support member 12.

The screen-mounting support member 12 is an elongate member as shown in FIG. 1 and FIG. 2. The screen-mounting support member 12 has a housing which is formed of plastics, metals or a combination thereof. Preferably, the screen-mounting support member 12 is formed by extrusion. When fastened to a first wall 20, a longitudinal extent of the screen-mounting support member 12 is vertical or substantially vertical. Furthermore, the screen-mounting support member 12 extends from the first wall 20 within or is substantially parallel to a plane defined by a bath tub wall 22. In cross-section, the housing 19 is substantially a trapezium, preferably a right-angled trapezium by virtue of having a pair of parallel sides and at least one right angle, as shown in FIG. 3 and FIG. 4. The housing has a mounting-wall 24a, a contact-wall having a first contact surface 24b, an inward-facing wall 24c and an outward-facing wall 24d. The inward-facing wall 24c and the outward-facing wall 24d are parallel or substantially parallel with the bath tub wall 22 and/or with each other. The screen-mounting support member 12 has a biasing means 26, positioned internally, enclosed by the four walls 24a, 24b, 24c, 24d. The screen-mounting support member 12 may have at least one aeration aperture or hole and/or mesh to permit aeration or air circulation within the screen-mounting support member 12 to reduce or limit moisture within the screen-mounting support member 12, whether at an end of or anywhere along the longitudinal extent of the screen-mounting support member. The screen-mounting support member 12 may have an opening at an end through which to access an internal space within the screen-mounting support member 12, said opening which may be the same as or may be in addition to the aeration aperture. The said opening at either or both ends of the screen-mounting support member 12a nd/or the housing 19 may be closeable or sealable with one or more caps, not shown, which are preferably removable.

The mounting-wall 24a is opposite the first contact surface 24b. The mounting-wall 24a extends in a plane which is perpendicular or substantially perpendicular to the bath tub wall 22. The mounting-wall 24a is engageable with the first wall 20 directly and/or indirectly, via a wall fixing plate 28. The mounting-wall 24a has at least one, and in this case, two protruding lips 30, as shown in FIG. 4. Said lips 30 are abuttable with the first wall 20 such that the wall fixing plate 28 is hidden from view by the lips 30. More importantly, the lips 30 prevent or inhibit water from reaching the wall fixing plate 28, which could result in rust and/or rot.

The wall fixing plate or element 28 is an elongate plate which is fastenable to the first wall 20 via a fastener 32. The fastener 32 may also be referred to as a wall-mountable fastener. The wall-mountable fastener 32 in the first embodiment comprises at least one screw, nail or bolt, although other means could be envisioned such as at least one magnet, double-sided tape, glue, or any other suitable adhesive. The wall fixing plate 28 also allows for the weight of the mounting wall to be distributed, potentially reducing structural failure. The mounting-wall 24a may be fastened either to the said wall fixing plate 28 by a separate fastener and/or by interference fit and/or by being slideably engageable with the wall fixing plate, such that the mounting-wall 24a is not directly fastened to the first wall 20. Having a separate wall fixing plate 28 allows different screen-mounting support member 12 to be mounted to the wall fixing plate 28, providing choice and ease of replacement and/or reducing the number of holes to be drilled into the first wall 20.

Alternatively, the fastener may fasten both the wall fixing plate and the mounting-wall to the first wall. For example, the same screw may traverse both the wall fixing plate and the mounting-wall. In a further modification to the present embodiment, the wall fixing plate may be omitted entirely, such that the mounting-wall may be directly fastenable to the first wall.

The first contact surface 24b extends in a first plane 34. The first contact surface 24b meets the inward-facing wall 24c at a non-perpendicular and interior angle, which in this case, is obtuse. Similarly, the first contact surface 24b meets the outward-facing wall 24d at a non-perpendicular and exterior angle, which is in this case acute. Thus, the first contact surface 24b is non-perpendicular relative to bath tub wall. Preferably, the first contact surface 24b has a sealing element 36 and a recess 38.

The sealing element 36 comprises at least one, and in this case two, elongate cylinders 40 extending at least in part along a longitudinal extent of the screen-mounting support member 12. The or each elongate cylinder 40 is partly recessed into the first contact surface 24b, although this need not necessarily be the case. The elongate cylinders 40 are formed of a waterproof material, such as plastics or preferably rubber.

The recess 38 forms a drainage channel 42 for channelling water or other liquids into the bath tub. The recess 38 is shaped to receive a portion of the further support member 14. The recess 38 in the first contact surface 24b extends at least in part along a longitudinal extent of the screen-mounting support member 12. The recess 38 is bounded on one side by the outward-facing wall 24d. The outward-facing wall 24d may optionally have a least one ridge and/or groove (not shown) to further improve the channelling of the water. Said ridge and/or groove may face and/or contact the said portion of the further support member 14. Furthermore, the recess 38 has an aperture 44.

The drainage channel 42 channels liquid such as water towards the bath, particularly when the said portion of the further support member 14 is received in the recess 38.

The aperture, opening or slit 44 extends along a substantial longitudinal extent of the recess 38. The aperture 44 provides a passage for the screen 16 such that the screen 16 is at all times positioned in the aperture 44. The aperture 44 is bounded by at least one screen-contacting wiper 46.

The screen-contacting wiper 46 or any other suitable screen-contacting element which is suitable for removing moisture is a wiper element which is in contact with the screen 16. The screen-contacting wiper 46 prevents or inhibits liquids such as water and/or soap scum from entering the screen-mounting support member 12 by removing said liquids from the screen 16. In this case, the screen-contacting wiper 46 is at least one elongate cylinder, similar to the sealing element 36, extending substantially along the longitudinal extent of the screen-mounting support member 12. The screen-contacting wiper 46 is formed of a waterproof material. The screen-contacting wiper 46 may be formed of metal, plastics, or preferably, rubber. The screen-contacting wiper 46 is positioned at least on the same side as the inward-facing wall 24c. In this case, there are two screen-contacting wipers 46, such that there is at least one elongate cylinder on either side of the screen 16, to provide a narrow passage for the screen 16. Having a screen-contacting wiper 46 on either side of the screen 16 also has the advantage of the system being usable with a shower which can be positioned on either side of the screen 16. The screen-contacting wiper 46 is, in-use, fixed. Thus, when the screen 16 is biased towards the screen-mounting support member 12 by the biasing means 26, the screen 16 is slideably moveable against the or each screen-contacting wiper 46. This arrangement also provides a self-cleaning screen 16. By removing excess water, the arrangement reduces or inhibits the deposition of limescale and other undesirable residue onto the screen 16. The screen-contacting wiper 46 being positioned within the recess 38 within the screen-mounting support member 12 provides a hidden, internal cleaning system. Due to the irregular cross-section of the screen-mounting support member 12, this internal cleaning system does not require additional space.

The biasing means 26 comprises a roller around which the screen 16 is wrappable. The roller is substantially elongate along the longitudinal extent of the screen-mounting support member 12.

The roller is biased into rotating in one direction to wrap the screen 16 around itself. Said direction may be clockwise or, in this case, anticlockwise. The roller is biased into rotating by means of at least one spring (not shown). Thus, the biasing means 26 is a spring-loaded roller.

The further support member 14 is an elongate element moveable relative to the screen-mounting support member 12. The further support member 14 is complementarily shaped to be mateably engageable with the screen-mounting support member 12. The further support member 14 is formed of plastics, metal or a combination thereof. Similarly to the screen-mounting support member 12, the further support member 14 is formed by extrusion. In-use, the further support member 14 is vertical or substantially vertical. The further support member 14 has a core portion 48a, a handle element 48b. Optionally, the further support member 14 may have at least one ergonomic surface 48c.

The core portion 48a has an external surface 50a, itself divided into a second contact surface 52a and at least one, but preferably two, handle-facing surfaces 52b. If the core portion 48a is hollow, as it is in this case, the core portion 48a additionally has an internal surface 50b. The core portion 48a further has a screen-clasping element 54.

The second contact surface 52a is angled such that it is in a plane parallel or substantially parallel to the first plane 34.

The screen-clasping element 54 comprises a protrusion to hold or clasp the screen 16. The screen-clasping element 54 extends from the second contact surface 52a, in a parallel or substantially parallel plane relative to the bath tub wall 22. The screen-clasping element 54 is receivable within the recess 38. In this case, the screen-clasping element 54 is a folded finger-like protrusion in cross-section, such that the screen 16 is trapped within the screen-clasping element 54. The screen-clasping element 54 may substantially seal or close the recess 38 such as by interference fit. The screen-clasping element 54 prevents or inhibits lateral movement of the further support member relative to the screen-mounting support member 12 when the screen-clasping element 54 is received within the recess 38.

The handle element 48b is T-shaped in cross-section and extends from the core portion 48a. By being accessible from either side of the screen 16, the handle element 48b provides a means to grasp the screen 16 from within or outside of the bath when the shower-screen retraction system 10 is in the retracted condition or in the extended condition. The long-branch of the cross-sectional T-shape or web of the handle is parallel or substantially parallel to the screen-clasping element 54 and/or the bath tub wall 22. The short-branches of the cross-sectional T-shape are perpendicular or substantially perpendicular to the bath tub wall 22. Similarly to the core portion 48a, the handle element 48b has an external-handle surface 56a and an internal-handle surface 56b. The external-handle surface 56a is divided into an outward surface 58a and at least one gripping surface 58b. The outward surface 58a may be planar or substantially planar and substantially parallel to a second wall (not shown).

The ergonomic surface 48c or means to improve the graspability or ease with which the user grasps the further support member 14 is a coating or texture applied to, fastened to or integrally formed with at least part of the further support member 14. The ergonomic surface 48c comprises a high grip surface and/or at least one gripping rib. The ergonomic surface 48c is preferably positioned on at least part of the external-handle surface 56a and, in this case, also on at least part of the handle-facing surfaces 52b, although this need not necessarily be the case. The ergonomic surface 48c extends along at least part of the longitudinal extent of the further support member 14.

The screen or shower-screen or self-retracting curtain 16 is, in use, a barrier to prevent or inhibit liquid such as water from being projected beyond the bath tub wall 22 when a user is showering. The shower-screen retraction system 10 and/or screen 16 has a retracted condition and an extended condition. When in the extended condition, the screen 16 extends along a second plane. In this case, the second plane is or is substantially parallel to at least one of the inward-facing wall 24c, the outward-facing wall 24d, and the bath tub wall 22. The screen 16 has an inward-facing screen surface 60a and an outward-facing screen surface 60b. The screen 16 comprises a material which is waterproof or substantially waterproof, on at least the inward-facing screen surface 60a. The screen 16 may optionally have antimicrobial properties, such as by being subjected to an antimicrobial treatment. The screen 16 may be formed at least in part of plastics. A suitable material may be Gore-Tex (RTM). The screen 16 is preferably pliable and/or may be formed of a plurality of slats. The screen 16 has a first screen end 62a, a second screen end 62b, a top screen edge 62c and a bottom screen edge 62d.

The first screen end 62a is associated with or held by the biasing means 26 and/or the screen-mounting support member 12.

The second screen end 62b is opposite the first screen end 62a and is associated with the further support member 14. More specifically, the second screen end 62b is associated, held or clasped by the screen-clasping element 54.

Preferably in this arrangement, the shower-screen retraction system 10 is devoid of any further supporting member or framework or of a guiding rail. Thus, at least the top screen edge 62c, and in this case, both the top screen edge 62c and the bottom screen edge 62d are free of any supporting structure. Therefore, the further support member 14 and by extension, the screen 16 are movable both longitudinally and laterally relative to the bath tub wall 22.

Optionally, the shower-screen retraction system 10 may comprise a further sealing element 64. The further sealing element 64 is an elongate element, positioned at or adjacent to the bottom screen edge 62d for channelling water running down the screen 16 towards the bath when the screen 16 is in the extended condition. The further sealing element 64 extends substantially along a longitudinal extent of the bath tub wall 22. The further sealing element 64 is, in this case, preferably made of plastics, metal or a combination thereof and is formed by extrusion. The further sealing element 64 is permanently or, preferably, temporarily fastened to the top of the bath tub wall 22. The further sealing element 64 may be fastened by double-sided adhesive tape, preferably specialist waterproof double-sided tape, although other alternatives, such as a suction system, an adhesive or fastener may be envisaged.

The connector 18 is a means for securing the second screen end 62b to be spaced-apart from the screen-mounting support member 12 and/or the first screen end 62a when the shower-screen retraction system 10 is in the extended condition. The connector 18 is positioned at or adjacent to at least the second screen end 62b. Preferably the connector 18 is associated with the further support member 14. The connector 18 comprises a first connector part 66a and a second connector part 66b. In this arrangement, the connector 18 is a latch-and-lock system.

The first connector part 66a comprises at least one, and preferably two, latches 68. The first connector part 66a is engageable with the second connector part 66b. The first connector part 66a is positioned at or adjacent to the second screen end 62b and/or the further support member 14. In this case, the or each latch 68 projects substantially perpendicularly from the outward surface 58a of the external-handle surface 56a. The or each latch 68 has at least one indent 70. The second connector part 66b is or comprises a lock or locking system, engageable with the first connector part 66a. The second connector part 66b is formed of plastics, metal or preferably, a combination thereof. The second connector part 66b is fastenable to the second wall via a fastening means 72. The second connector part 66b has a longitudinal extent which is less than the longitudinal extent of the screen-mounting support member 12 or the further support member 14. Thus, the second connector part 66b is smaller than the screen-mounting support member 12 and/or the further support member 14. The second connector part 66b has an actuatable component 74 held within a connector-housing 76, for locking or unlocking the securing of the screen 16 when in the extended condition.

The fastening means 72 comprises a fastener or fastening mechanism. The fastening means 72 may also be referred to as a connector-fastener. Said fastener may include at least one of a screw, a magnet, a bolt, double-side tape, glue and any other adhesive. In this case, the fastening means 72 includes four screws.

The actuatable component 74 is a button or toggle, at least a portion of which is accessible to the user, as shown in FIGS. 6 and 7. The actuatable component 74 is made of plastics, metal or a combination thereof. The actuatable component 74 may be integrally formed or may have multiple engageable parts, as shown in FIG. 5. The actuatable component 74 has at least one connector-recess 78 for receiving at least part of the or at least one latch 68. The actuatable component 74 also has at least one protrusion or catch 80 and at least as many catches 80 as there are latches 68 and/or indents 70. The actuatable component 74 may optionally be biased into a position by a further biasing means or biaser 82, such as at least one and, in this case, two springs 84.

The or each catch 80 is engageable with the at least one indent 70 of the or each latch 68. The or each catch 80 prevents or inhibits the first connector part 66a and the second connector part 66b from being spaced-apart from each other when the or at least one of the catches 80 is engaged with the or at least one of said indents 70. Thus, the or each catch 80 is appropriately positioned and oriented on the actuatable component 74 relative to the at least one indent 70. Furthermore, the or each catch 80 is complementarily-shaped and appropriately-sized to be engageable with the or each corresponding indent 70. The or each catch 80 is formed of plastics, metal or a combination thereof. The catch 80 may be integrally formed or permanently fastenable with the actuatable component 74, however, in this case, the or each catch 80 is separably fastenable with the actuatable component 74 by an actuator-fastener 86. Said actuator-fastener 86 may be at least one screw, at least one bolt, glue, tape, adhesive, any other fastening means or any combination thereof.

The connector-housing 76 is fastenable to the second wall and provides a support for the actuatable component 74. The connector-housing 76 is formed of plastics, metal or a combination thereof. The connector-housing 76 comprises an outer casing 88a and an actuator-rail 88b. The outer casing 88a has at least one aperture 90 or opening through which at least one latch 68 is receivable.

The actuator-rail 88b or button housing or actuatable component housing provides a guiding support for the actuatable component 74. The actuator-rail 88b has at least one aperture 92 or opening, and in this case, four apertures 92 through which the screws are insertable. Furthermore, the actuator-rail 88b is abuttable against the second wall, such that the fastening means 72 may be used to fasten the actuator-rail 88b and thereby, the second connector part 66b to the second wall.

In use, the user or a builder first needs to install the shower-screen retraction system 10 before the system 10 can be used. If the housing is fitted with a removable cap at one or either end, at least one cap is removed so as to provide an open end. The screen and/or biasing means, preferably the screen wrapped around the biasing means, is slideably insertable into the housing via the or one of the open ends thereof. Optionally, the open end may subsequently be closed by the or a cap. The wall fixing plate 28 is fastened to the first wall 20 by the fastening means or fastener 32, in this case, by at least one screw. Before or after fastening the wall fixing plate 28, the screen-mounting support member 12 is engaged with the wall fixing plate 28, whether by being complementarily shaped and/or slidably engageable with the wall fixing plate 28, by the same or a different fastening means. The wall fixing plate 28 and/or the screen-mounting support member 12 are positioned against the first wall 20 such that the screen-mounting support member 12 is vertical or substantially vertical.

The builder fastens the actuator-rail 88b to the second wall, preferably by screwing the at least one and preferably four screws. The second connector part 66b needs to be positioned at a height and in an orientation suitable to receive the first connector part 66a. The connector 18 needs to also be positioned and oriented such that the further support member 14 is vertical or substantially vertical. The catches 80 are fastened to the actuatable component 74. The actuatable component 74 is then inserted into the actuator-rail 88b and enclosed within the outer casing 88a. The shower-screen retraction system 10 is now ready for use during showering. No further support members or guiding rails are required, thus the shower-screen retraction system 10 is a railless framework.

Optionally, the user may temporarily or permanently fasten the further sealing element 64 to the edge of the bath tub wall 22, to prevent or inhibit a liquid running down the in-use screen 16 from running onto the floor outside of the bath tub wall 22. If the further sealing element 64 is used, this is positioned on the bath wall 22 outwards relative to the shower and in-use screen 16, such that the in-use screen 16 is positioned between the further sealing element 64 and the shower. Should the shower-screen retraction system 10 need to be disassembled, the above steps are done in reverse order.

When the shower-screen retraction system 10 is not in use, the shower-screen retraction system 10 is in the retracted condition as shown in FIG. 1. The biasing means 26 comprises a biaser or biasing mechanism which imparts a biasing force upon the screen 16. In the retracted condition, the screen 16 is at least partly retracted, such that the screen 16 is at least partly wrapped around the spring-loaded roller. Furthermore, in the retracted condition, the further support member 14 abuts the screen-mounting support member 12 such that the screen-mounting support member 12 and the further support member 14 are mateably engageable in the first plane 34. Specifically, the second contact surface 52a of the further support member 14 abuts the first contact surface 24b and/or the or each sealing element 36 of the screen-mounting support member 12, to form a seal. Thus, the shower-screen retraction system 10 forms a discrete, compact and discreet unit when not in use.

When a user desires to have a shower, they would turn on the shower and step into the bath tub. The user would then grasp the handle element 48b of the further support member 14 and/or the second screen end 62b. The user then pulls the further support member 14 away from the screen-mounting support member 12 and/or first screen end 62a, imparting sufficient force to counteract the biasing force exerted by the biasing means 26.

The further support member 14 is held by the user vertically or substantially vertically within the vicinity of the second connector part 66b. The or each latch 68 of the first connector part 66a is then inserted through the or each aperture 90 in the outer casing 88a. The or each latch 68 is then at least partially received within the or each connector-recess 78 of the actuatable component 74. The spring or springs 84 bias the actuatable component 74 in a direction such that the or each catch 80 engages with the or each corresponding indent 70. When at least one catch 80 and the corresponding indent 70 are engaged, the first connector part 66a and the second connector part 66b are temporarily locked together. The connector 18 is now in a locked condition as shown in FIG. 6. Thus, the connector 18 secures the further support member 14, and thereby, the second screen end 62b to be spaced-apart from the screen-mounting support member 12 and/or the first screen end 62a. The biasing means 26 continues to exert a biasing force resulting in the screen 16 being in at least partly taut or in a planar condition when in-use. The screen 16 provides a waterproof planar barrier between the screen-mounting support member 12 and the connector 18. Water and/or other liquids and/or soap scum run down the inward-facing screen surface 60a of the taut screen 16 and into the bath. A temporary shower cubicle is thereby created.

When the user has finished showering, they may want to exit the shower cubicle. To do so, the user actuates the connector 18 from the locked condition into the unlocked condition. In particular, the actuatable component 74 is pushed or depressed by the user, to counter the force of the spring or springs 84. In this case, the actuatable component 74 or button is pushed down as shown in FIG. 7, however, other arrangements may be envisioned where another direction and/or action may be required to unlock the second connector part.

Actuating the actuatable component 74 results in the catch or catches 80 being disengaged from the indent or indents 70. The latch or latches 68 are thus removeable from the second connector part 66b. The biasing means 26, in this case the spring-loaded roller, biases the screen 16 and thereby the further support member 14 towards the screen-mounting support member 12. The screen 16 is drawn into the screen-mounting support member 12 by the biasing means 26 and is compactly wrapped around the roller. As the screen 16 follows a path adjacent to the at least one wiper or screen-contacting wiper 46 on the inward-facing screen surface 60a, the screen-contacting wiper 46 prevents or inhibits water and soap scum on the inward-facing screen surface 60a from entering the screen-mounting support member 12. Under gravity, the scraped-off water and soap scum run down the drainage channel 42, against the screen-contacting wiper or elements 46 and/or against the outward-facing wall 24d of the screen-mounting support member 12. The drainage channel 42 channels this water and soap scum towards the bath tub. The screen-contacting wiper 46 thereby also effortlessly cleans the screen 16 each time the screen 16 is drawn into the screen-mounting support member 12. The result is a self-cleaning, more sightly screen 16 when in-use and an increased lifespan of the shower-screen retraction system 10. The shower-screen retraction system 10 returns to the retracted condition until it is next used. Whilst the housing 19 is substantially a trapezium in cross-section by having one pair of parallel sides, alternative cross-sections may be envisioned. Said alternative cross-sections may include circular or non-circular, regular or irregular polygons such as square, rectangular, pentagonal, hexagonal, any trapezium, or a trapezoid by having no parallel sides, D-shaped, elliptical or at least partly curved cross-sections. At least one wall of the screen-mounting support member housing may continuously transition into another wall without necessarily forming an edge. The further support member would also preferably, but not necessarily, be complementarily shaped to such an alternative cross-section.

Whilst in this arrangement, the various sub-components of the screen-mounting support member 12 and/or the further support member 14 are not detachably removable, in an alternative embodiment, at least one of the screen, the sealing element or elements, the screen-contacting wiper or elements, and the biasing means may be detachably removable from each other and/or from the screen-mounting support member and/or the further support member. This would allow the sub-components to be easily cleanable and/or replaceable. In particular, the screen-mounting support member may have an opening and/or hinged arrangement to allow access to the biasing means and/or internal space within.

In this arrangement, the screen-mounting support member 12 has two lips 30 and the further support member 14 and/or the connector 18 has no lips 30. However, there could be any number of lips, including none, at least one or at least three.

Whilst in this case, the screen-mounting support member 12 is fastenable to the first wall 20 via the wall fixing plate, there may be no wall fixing plate. Instead, the screen-mounting support member may be fastenable to the first wall directly by any means or mechanism including magnets, glue, double-sided adhesive tape, at least one screw, and/or at least one hook. Alternatively, the screen-mounting support member may have at least one first magnet and the wall fixing plate may be or may have at least one second magnet complementary to the first magnet.

Although the screen-mounting support member 12 and/or the further support member 14 are vertical or substantially vertical, it could be envisioned that they may be slightly tilted. In the extended condition, the bottom screen edge would thereby be tilted inwards relative to the bath tub wall, such that water running down the extended screen would be more likely to flow into the bath tub.

The screen-mounting support member 12 and/or the further support member 14, although formed by extrusion in this case, may alternatively be formed by connecting sheets of metal and/or plastics together.

The biasing means 26 is, in this arrangement, contained within the screen-mounting support member 12. Furthermore, the biasing means 26 is a spring-loaded roller, around which the screen 16 is wrappable. However, alternative arrangements could be envisioned. For instance, the biasing means may be within the further support member, instead of or in addition to the screen-mounting support member. Alternatively, the biasing means could be only partially or even not at all contained internally within the screen-mounting support member. The roller could instead be centrered on and/or rotatable around an elongate member, central pole or bar. The central pole could extend beyond at least one end or beyond both ends of the roller and may be anchorable to a wall ora tub.

The roller is in this case spring-loaded. However, alternative means could be envisioned. The roller may be electronically actuatable, such that a user may press a button or remote that causes the roller to exert the retracting, biasing force. This alternative arrangement may be advantageous as it may result in a more controlled retraction of the screen.

The screen 16 may not even be wrappable around the biasing means 26. For example, the screen-mounting support member may have at least one biasing roller, and preferably at least two. The roller or rollers may be substantially elongate along the longitudinal extent of the screen-mounting support member or there may a plurality of pairs of rollers, one above the other. If the screen of the path is along and/or between the rollers, the screen would be entrained by the rollers into the screen-mounting support member. The screen would then be foldable into a space within the screen-mounting support member. Such rollers may even wring the screen as it is biased inwards, such that no wiper element need even be required.

In this arrangement, each wiper element and/or the sealing element 36 comprises at least one elongate element which is circular in cross-section. However, the elongate element may be square or rectangular, triangular, foil-shaped, or any other polygon, whether regular or irregular, D-shaped or at least partly curved in cross-section. It could easily be envisioned that the sealing element and/or each screen-contacting wiper may have any number of elongate elements, including none. The sealing element may be positioned on the further support member instead of or in addition to the screen-mounting support member. Furthermore, in this arrangement, each wiper element is fixed. However, it could be envisioned that the or at least one of the wiper elements are rotatable about its longitudinal axis. A screen-contacting wiper may provide a further cleaning mechanism in the form of residue scraping, including when the system is biased towards the extended condition; in addition to removing water when the screen is biased towards the retracted condition. Alternatively, the screen may be wrapped so tightly around the biasing means that liquid is evacuated by squeezing.

The sealing element in this arrangement, prevents or inhibits contact between the screen-mounting support member 12 and the further support member 14, as well as preventing or inhibiting lateral movement by friction. In addition to or instead of the sealing element, screen-mounting support member and the further support member may have complementary magnets such that said magnets help maintain the shower-screen retraction system in the retracted condition and reduce or inhibit fatigue of the biasing means.

Whilst the current embodiment has an elaborate further support member 14 having a core portion 48a and a handle element 48b for graspability, in an alternative embodiment, the further support member may be simpler for ease of lifting and moveability. For instance, the further support member may be an elongate strip or plate of plastics or metal. The simpler further support member may be fastened such as by glue or stapling to or adjacent to the second screen end.

The handle element, which is substantially T-shaped in this arrangement, may have alternative cross-sections such as by having curved short branches.

The screen-clasping element 54 in this arrangement, is a curved protrusion which traps or clasps the second screen end 62b. However, it could be envisioned that the screen may be held or grasped by another means or mechanism. For instance, the second screen end may not be curved or the second screen end may have at least one aperture or eye and the further support member may have a hook, rope or complementary means or mechanism engageable with the at least one eye, or vice-versa. There may be no protrusion projecting from the second contact surface in which case, the second screen end may be receiveable internally.

In a further alternative arrangement, there may be no further support member. In this alternative arrangement, the screen may have at least part of the connector directly connected or connectable to the second screen end, for example, the second screen end may have at least one hook and/or at least one eye and/or at least one latch and/or lock. This might be advantageous as being lighter than a further support member. In this alternative arrangement, the screen may still be pliable, and/or be formed of a plurality of connected slats or strips of plastics. The slats may be hinged to one another or connected by flexible joints or foldable plastic, such that the screen is wrappable around the spring-loaded roller in the retracted condition and/or foldable in an internal space of the screen-mounting support member; and extends in a plane when in the extended condition.

In this embodiment, the second support element has at least one ergonomic surface 48c. It could be envisioned that there is a plurality of ergonomic surfaces or none at all, for ease of manufacturing.

The screen 16, when in the retracted condition, is currently tightly wrapped around the biasing means 26. However, it could easily be envisioned that the screen has at least one spacer element or finger, for spacing apart the folds of the screen when wrapped around the biasing means. This would permit the inward-facing screen surface to dry when in the retracted condition.

In the current arrangement, the connector 18 has a depth such that when in the extended condition, the depth causes there to be a gap or spacing between the further support member 14 and the second wall. To avoid such a gap, the outward surface of the handle element may have a protruding lip abuttable against the second wall, and/or at least one of the first and second connector parts may be recessable into the second wall and/or into the further support member. In a further alternative, the first connector part may extend from a side of the further support member and/or second screen end such that the outward surface and/or screen may be directly abuttable against the second wall.

Although in the connector 18 and actuatable component 74 or element are substantially vertical in this arrangement, it could be envisioned that the connector and/or actuatable component may be in alternative orientations. For instance, the connector and/or actuatable component may be substantially horizontal or at any angle therebetween. The actuatable component 74 is, in this arrangement, accessible via the top of the second connector part 66b and is depressable in an in-use downwards direction. However, being actuatable in an in-use upwards or sideways direction and/or accessible from another side of the second connector part may be advantageous as currently, the button is only accessible via the gap or narrow spacing which may be difficult to access.

In this case, the first connector part 66a is associated with the second screen end 62b and/or the further support member 14 and the second connector part 66b is engageable with the second wall, however the first and second connector parts positions could easily be reversed. Furthermore, the connector 18, comprising two parts in this case, could easily comprise a single part or more than two parts. Furthermore, instead of or in addition to the latch-and-lock system of this arrangement, the connector may be at least one of a hook-and-eye system; mateably-engageable protrusions; interlockable ledges; and at least one suction cup. In a further alternative embodiment, the handle element may function as the connector, such that a protrusion of the handle element is interengageable with a projecting ledge or lip or hook.

Although in this case, the shower-screen retraction system 10 is installed above a bath tub wall, it could easily be installed above a shower basin wall instead. In this arrangement, the shower-screen retraction system 10 is aimed for use to prevent a barrier when showering, it could be easily envisaged that other uses may be found for the self-cleaning, retractable shower-screen retraction system. For instance, the screen retraction system could be used as a barrier against rain and/or sunshine if the screen is at least partially opaque. The shower-screen retraction system can also be folded around at least one vertical member such that the screen is taut in at least two non-parallel planes.

Referring now to FIGS. 8 to 12, there is shown a second embodiment of a shower-screen retraction system 110 in a closed condition.

Features of the second embodiment which are similar to features of the first embodiment have similar reference numerals, with the prefix ‘1’ added. New features have reference numerals between ‘200’ and ‘300’.

The shower-screen retraction system 110 of the second embodiment is similar to the shower-screen retraction system 10 of the first embodiment, having a similar wall-mountable sliding assembly, comprising a screen-mounting support member 112, a further support member 114, a screen 116, and a locking assembly comprising a connector 118. Detailed description of the common features is omitted for brevity.

The screen-mounting support member 112 of the second embodiment is similar to the screen-mounting support member 12 of the first embodiment, having a housing 119, a biasing means 126, and, preferably, at least one cap 210, shown in FIGS. 8 and 9 but omitted in FIG. 10 for clarity. Detailed description of the common features is omitted for brevity. Unlike the first embodiment, the screen-mounting support member 112 has preferably no lips in the second embodiment.

Furthermore, the housing 119 preferably is or is substantially square or rectangular in lateral cross-section, rather than a trapezium. The aperture or slit 144 for permitting the screen 116 therethrough is preferably not positioned or located within a recess. Additionally or alternatively, the aperture 144 is preferably offset along the lateral extent of the first contact surface 124b relative to a centre thereof. The aperture 144 is closer to an edge or corner of the housing 119, which may be formed by the first contact surface 124b and the outward-facing wall 124d, or preferably as shown, the inward-facing wall 124c. One or more corners of the housing 119 may be chamfered or rounded.

The or each of the at least one screen-contacting wipers 146 is not or not substantially located within a recess. Instead, the or each screen-contacting wiper 146 may be or be substantially positioned at, on, in, around and/or outside of the housing 119, for ease of cleaning. The two screen-contacting wipers 146 shown in FIG. 10 are preferably U-shaped. Each said U-shaped wiper 146 surrounds or substantially surrounds an edge of the aperture 144 such that each wiper 146 is simultaneously inside and outside the housing 119. The housing 119 of the second embodiment preferably comprises no sealing element.

The housing 119 further comprises at least one of: one or more aeration holes, and a mesh portion, for improving the aeration and therefore drying of the screen. Said aeration holes, not shown, are rectangular or square in this case, although circular, part circular, triangular, hexagonal, octagonal, or any other polygon, or slits may be envisioned.

The wall mountable sliding assembly in the second embodiment further comprises a cover 212, although this feature may be omitted. The cover 212 is formed of plastics, metals, or a combination thereof, and/or by extrusion. The cover 212 extends along at least a major portion of, and preferably, the whole longitudinal extent of the shower-screen retraction system 110 and/or the housing 119.

The cover 212 may be connectable to the housing 119 to a corner, or to a wall at or adjacent to a corner or an edge formed by two of the walls 124a, 124b, 124c, 124d of the housing 119. The corner may be formed by the first contact surface and the inward-facing wall. Preferably as shown, the cover 212 is connectable to the outward-facing wall 124d adjacent to the corner formed by the first contact surface 124b and the outward-facing wall 124d.

The cover 212 is hingeably connected or connectable to the shower-screen retraction system 110, by way of at least one hinge, not shown, although any other suitable connecting means, such as interference fit, may be envisioned. Said at least one hinge preferably extends along at least a major part of the longitudinal extent of the shower-screen retraction system 110 and/or the cover 212. The cover 212 may be in either an open condition or in a closed condition. The cover 212 also comprises at least one cover-closure element, not shown, although this feature may be omitted.

The cover-closure element preferably retains or maintains the cover 212 in the open condition, or preferably, the closed condition and/or inhibits or prevents the cover 212 from accidentally being moved or actuated into the open condition. It may be envisioned however, that the cover-closure may bias the cover into the closed condition or into the open condition. The cover-closure element comprises at least one magnet, but any alternative or additional retaining means, fastening means or biasing means, such as at least one hook, eye and hook, hook and loop fasteners, interference fit press-stud, any other suitable fastening means, or combination thereof may be envisioned. The cover 212 is generally a U-shape in lateral cross-section, wherein the U-shaped cover 212 has a long cover-portion 214 and two short cover-portions 216, extending from the long cover-portion 214. The long cover-portion 214 has a width at least equal to the width or lateral extent of the first contact surface 124b. One or both short cover-portions 216 have a width at least equal to a maximal width, diameter or lateral extent of the further support member 114. Preferably, the cover 212 is dimensioned such, when closed, a gap or space 218 is formed between the long cover-portion 214 and the first contact surface 124b. Said gap 218 is preferably between 0.5 cm and 5 cm, and more preferably about 1 cm in a direction normal to the long cover-portion 216 and/or the first contact surface 124b. These dimensions enable the cover 212, when in the closed condition, to at least partially, or, preferably, completely hide, surround or enclose the screen-contacting wipers 146 and/or the further support member 114, as best illustrated in FIG. 8.

The wall fixing plate or element 128 of the second embodiment is similar to the wall fixing plate or element 28 of the first embodiment, although it may be envisioned that the wall fixing element may be entirely omitted. The wall fixing element 128 is positionable between the housing 119 and the first wall, not shown. Preferably in this embodiment, the wall fixing element 128 is or is substantially U-shaped in cross-section, similarly to the cover 212, having a long element-portion 220 and two short element-portions 222 extending therefrom. The wall fixing element 128 in this embodiment receives at least part of the housing 119 for providing a more secure fit.

The wall fixing element 128 is preferably detachably connectable with or detachably abuttable against the housing 119 for ease of installation, removal and end-of-life recyclability. The wall fixing element 128 is preferably formed of plastics in this embodiment, and/or by extrusion. An inner face 224 of the long element-portion 220 faces or abuts the mounting-wall 124a of the housing 119. Preferably, the wall fixing element 128 and/or mounting-wall 124a comprises at least one, and as shown in FIG. 11, four apertures, grooves, slits, slots or openings 226 for receiving therethrough fastening means such as one or more fasteners 132.

The or each fastener 132 of the second embodiment is similar to the or each fastener 32 of the first embodiment. Detailed description of the common features is omitted for clarity. Each fastener or wall-mountable fastener or bracket 132 comprises a projection or member insertable into or attachable to the first wall. Each projection may be a screw, protrusion, or nail, or any other means suitable for being insertable into a wall and being receivable in the or each opening 226 in the wall fixing element 128 and/or housing 119. The fastener 132 alternatively or, here, additionally comprises a stabilising element or portion 228 as shown in FIG. 12, although this feature may be optional.

The stabilising element 228 and/or the or at least one said fastener 132 preferably has two or more protrusions or prongs 230 positioned such that the stabilising element 228 and/or the or one said fastener 132 is or substantially is U-shaped in cross-section, as shown in FIG. 12. The stabilising element 228 and/or a first of the two said protrusions 230 engages with at least the inner face 224 of the wall fixing element 128 and/or an inner face of the housing 119 to prevent or inhibit the in-use screen-mounting support member 112 from leaning away from the first wall. The second of the two said prongs 230 is abuttable against an outer face 232 of the wall fixing element 128 and/or the housing 119.

In this embodiment, the shower-screen retraction system has at least one portion 234 which is recessed, and preferably complementarily shaped and positioned to receive, abut against or engage the second of the two said protrusions 230. The or each said recessed portion 234 is preferably on the outer face 232 of the wall fixing element 128 and/or the screen-mounting support member 112. Preferably, a depth of the or each recessed portion 234 is similar or at least equal to or greater than a width or thickness of the or each second protrusion 230 such when the or each second protrusion 230 is received in the recessed portion 234, the in-use outer face 232 of the wall fixing element 128 and/or housing 119 of the screen-mounting support member 112 is flushly or substantially flushly abuttable against the first wall. Said second protrusion 230 may also function to maintain the screen-mounting support member 112 and/or wall fixing element 128 vertically or substantially vertically, particularly if the screen-mounting support member 112 does not abut or flushly abut the first wall.

The stabilising element may have a member insertable into or engageable with the first wall directly, dispensing with the need for a separate projection, but preferably, the stabilising element 228 further comprises at least one through-bore 236 through which the projection of the fastener 132 is receivable.

The further support member 114 of the second embodiment is similar to the further support member 14 of the first embodiment; and detailed description of the common features is omitted for brevity. In the second embodiment, preferably the further support member 114 is rigid and elongate and may be formed of plastics, metal or a combination thereof. Referring back to FIG. 9, the further support member 114 is or is substantially a pole, rod or bar, which may be formed by extrusion. The diameter or lateral extent of the further support member 114 or part thereof is preferably greater than a width of the aperture 144 such that further support member 114 or a part thereof cannot in-use be received therethrough into the housing 119. The further support member 114 comprises a core portion or support portion 148a and a handle element 148b which are integrally formed and/or non-colinear with each other, as best shown in FIG. 9. The handle element 148b provides a means to grasp the screen 116 from within or outside of the shower or bath when in a retracted condition or when in the extended condition. The core portion 148a comprises here two or more core-subportions, but this may be optional.

The screen 116 preferably forms at least one pocket 238, and here, two pockets 238, in which the further support member 114 is associated with, at least in part receivable by, at or adjacent to the second screen end 162b. The further support member 114 extends between the two pockets 238, and preferably, the handle element 148b is positionable and graspable between the two pockets 238. In particular, each core-subportion is receivable in a pocket 238. The further support member 114 may be rotatable within and/or relative the pocket or pockets 238 and/or the screen-mounting support member 112. As shown in FIG. 9, the screen 116 may also comprise a recessed section 240 but this may be optional. This may further facilitate the grasping of the handle element 148b.

In the second embodiment, the handle element 148b has a second function of being or being part of the first connector part 166a of the connector 118, engageable with the second connector part 166b. The handle element 148b is therefore multifunctional.

The second connector part 166b comprises a hook element in the second embodiment.

The connector 118 further comprises at least one aperture 242, preferably a recessed portion 244, and a fastening means which may comprise a fastener, also referred to as a connector-fastener, wall-mountable fastener or wall-mountable bracket. The at least one aperture 242, recessed portion 244 and connector-fastener are or are substantially similar or identical to the aperture 226, recessed portion 234 and the wall-mountable fastener 132 of the screen-mounting support member 112 respectively. Detailed description of the common features is omitted for brevity. Said second connector part 166b may be engageable, preferably removably, and more preferably slideably removable, with the connector-fastener, itself fastened or fastenable or engageable to the second wall, omitted in FIG. 9 for clarity. This provides customisability and greater ease of replacement or cleaning.

The uses of the second embodiment are similar to the uses of the first embodiment. Detailed description of the common steps is omitted.

The second embodiment differs from the first embodiment in the following ways. The user obtains or is provided with a shower-screen retraction system 110 having a wall-mountable sliding assembly and a locking system, in a disassembled or partly disassembled condition.

To assemble the shower-screen retraction system 110, the user inserts the or each fastener 132 into the or each wall. This involves inserting the projection, here a screw or nail, through the through-bore 236 of the stabilising element 228 and into the corresponding wall. The protrusion or protrusions 230 of the stabilising element 228 are preferably oriented in-use in an upwards or generally upwards direction.

The user moves the back of the screen-mounting support member 112 towards the first wall, before inserting part of the or each fastener 132 through a corresponding aperture 226 in the screen-mounting support member or at least the housing 119 thereof.

If the shower-screen retraction system further comprises a wall fixing element 128, the wall fixing element 128 may be engageable with the screen-mounting support member 112 to provide a two-part system in an engaged condition. As the wall fixing element 128 comprises similar corresponding apertures 226, the two-part system, in either the engaged condition or a disengaged condition, is slideably engageable with the said at least one wall-mountable fastener 132. The or each fastener 132 is insertable through the corresponding apertures 226 simultaneously if the screen-mounting support member 112 or the housing 119 is engaged with or received within the wall fixing element 128, or in sequence if the screen-mounting support member 112 or the housing 119 thereof is not engaged with the wall fixing element 128. Alternatively, it could be envisioned that only the wall fixing element or the screen-mounting support member may be engageable with the fastener, even when the wall fixing element is engaged with the screen-mounting support member.

Once the or each fastener 132 is partly received in a said corresponding aperture, the wall fixing element 128 and/or the screen-mounting support member 112 or housing 119 thereof is lowered, preferably slideably, until engaged with the or each wall-mountable fastener 132 and the screen-mounting support member 112 or component parts thereof hang from or are suspended by the fastener or fasteners 132. Preferably, the inner face of the housing 119 is made to abut against the first protrusion 230. Thus, if a wall fixing element 128 is provided, said two-part system is slideably engageable with the said at least one wall-mountable fastener 132. In other words, the user slideably engages the wall-mountable sliding assembly with a first wall directly and/or indirectly via a wall fixing element 128 and/or a fastening means 132.

As there are preferably two protrusions 230, part of the housing 119 and/or the wall fixing element 128 is received between the two protrusions 230. The second protrusion 230 preferably engages with the recessed portion 234.

The or each second connector part 166b of the locking assembly is preferably similarly connected to its respective connector-fastener, which is preferably positioned on the second wall.

The user may have partly or fully assembled the screen-mounting support member 112 prior to connecting the screen-mounting support member 112 to the wall by doing at least one of the following: inserting the screen 116 and/or biasing means 126 into the housing 119; inserting part of the housing 119 and/or screen-mounting support member 112 into the wall mounting element 128, and connecting the cover 212 to the housing 119. If not fully assembled, the user may fully assemble the screen-mounting member 112. Optionally, the or each cap 210 may be inserted to close the or each open end of the housing 119.

To partly or fully disassemble the shower-screen retraction system 110, some or all the above steps are performed in reverse. The two-part system, or the components thereof, here the housing 119 or screen-mounting support member 110 and/or the wall fixing element 128, are therefore removably fastenable, connectable or engageable to the said further wall 20 via one or more wall-mountable fasteners 132, preferably slideably. Similarly, the second connector part 166b is removably connectable to the said wall via the connector-fastener, preferably slideably. In other words, as the two part-system, or screen-mounting support member 112 or wall fixing element 128 are slideably engageable with the at least one wall-mountable fastener 132; the screen-mounting support member 112 and/or the wall fixing element 128 are slidably removable.

When the shower-screen retraction system 110 is not in use, the screen 116 is in a retracted condition. In the retracted condition, the further support member 114 is abutted against the screen-mounting support member 112. Furthermore, the cover 212 is actuatable or movable into the closed condition. Preferably, the further support member 114 is abutted against the first contact surface 124b. This may be done by rotating the further support member 114 within the pockets 238 and/or by folding the screen 116. When the cover 212 is in the closed condition, the cover 212 surrounds, encloses, hides or contains the at least one screen-contacting wiper 146 and/or the further support member 114. In this embodiment, the cover 212 in the closed condition additionally surrounds, encloses, hides or contains the handle element 148b.

To use the shower-screen retraction system 110, the cover 212 is operated or moved into the open condition. The user operates the screen 116 into the extended condition by grasping and spacing apart the handle element 148b from the housing 119, and towards the second connector part 166b, exerting sufficient force to overcome the biasing force of the biasing means 126. The handle element 148b is made to engage the second connector part 166b, to prevent or inhibit the screen 116 from retracting into housing 119.

When the user desires to leave the shower or bath cubicle, they disconnect the first connector part 166a which is here, the handle element 148b, from the hook-shaped second connector part 166b. The biasing means 126 biases the screen 116 towards the retracted condition, wrapped around the biasing means 126 within the housing 119. The cover-closure element and/or the user may bias or move the cover 212 into the open condition or, preferably, the closed condition. Preferably, the cover-closure element maintains the cover 212 in the closed condition.

Whilst the cover 212 and/or the wall fixing element 128 are U-shaped and the further support member 114 is circular in cross-section in this embodiment, in an alternative embodiment, the cover, wall fixing element and/or further support member may be linear, a flat plate, a rectangle, L-shaped, C-shaped, D-shaped, at least partly curved, circular, oval, a chevron, or any other desirable polygon in cross-section.

The wall fixing element 128 is preferably detachably connectable to the housing 119, and via interference fit, but non-detachably connectable may be envisioned, and/or by means of a fastener. It may even be envisioned that at least part of or all of the mounting-wall of the housing may be omitted such that the screen and/or biasing means may be accessed therethrough.

Whilst in the second embodiment, the apertures 226 are spaced-apart from the corners, said apertures may be locking grooves and/or grooves extending from a corner or edge of the screen-mounting support member. This may enable the screen-mounting support member to be slid onto the fasteners from the side. The grooves may all extend from the same corner. Alternatively, a groove may extend along the lateral extent of a surface from one edge, and at least one further groove may extend from another other edge of the surface such that, to engage the fasteners with the grooves, the user would need to rotate the screen-mounting support member in a vertical or substantially vertical plane.

The slit 144, which is laterally offset, may easily be centrally located along the lateral extent of the first contact surface.

The further support member or core portion and the handle element may alternatively be non-integrally formed with each other. Instead, the further support member or the core portion thereof, and the handle element may be connectable with each other, whether separably or detachably, or non-detachably. In a further modification, the core portion and the handle element may be colinear with each other so as to form a linear pole or bar.

The second connector part may be fastenable to the second wall directly, instead of via a fastener. In an alternative embodiment, the stabilising element and/or the or at least one wall-mountable fastener and/or connector-fastener may have any other suitable cross-sections, such as T-shaped. Alternatively, the stabilising element and/or the or at least one wall-mountable fastener may have one prong or protrusion instead of at least two, so as be or substantially be L-shaped in cross-section.

It is therefore possible to provide a shower-screen retraction system which provides a waterproof barrier to prevent or inhibit water from inundating the floor in the immediate vicinity of the shower or bath. The shower-screen retraction system is compact and appropriate for tight spaces where a door may not be appropriate. Due to the self-retracting properties and the lack of rails, the shower-screen retraction system is self-cleaning, discreet and out of sight when not in use.

The words ‘comprises/comprising’ and the words ‘having/including’ when used herein with reference to the present invention are used to specify the presence of stated features, integers, steps or components, but do not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

The embodiments described above are provided by way of examples only, and various other modifications will be apparent to persons skilled in the field without departing from the scope of the invention as defined herein.

1. A shower-screen retraction system for providing a temporary self-retracting and self-cleaning barrier for a bath or a shower, comprising: a screen-mounting support member having a biasing mechanism and a housing; a screen having a first screen end, associated with the screen-mounting support member and/or the biasing mechanism, and a second screen end opposite to the first screen end; and at least one screen-contacting wiper for removing water on the screen, such that during retraction of the screen into the screen-mounting support member by the biasing mechanism means, the screen slides against the said screen-contacting wiper to self-clean.

2. A shower-screen retraction system as claimed in claim 1, further comprising a further support member associated with the second screen end.

3. A shower-screen retraction system as claimed in claim 1, further comprising a cover connectable to the housing, the cover having an open condition and a closed condition.

4. A shower-screen retraction system as claimed in claim 3, wherein the cover comprises a hinge such that the cover is hingeably connectable to the housing.

5. A shower-screen retraction system as claimed in claim 3, wherein the cover further comprises at least one cover-closure element for retaining the cover in the closed condition.

6. A shower-screen retraction system as claimed in claim 3, further comprising a further support member associated with the second screen end and wherein, when the screen is in a retracted condition, the further support member is abutted against the screen-mounting support member, and when the cover is in the closed condition, the cover surrounds the at least one screen-contacting wiper and/or the further support member.

7. A shower-screen retraction system as claimed in claim 2, wherein the said further support member comprises a handle element for enabling grasping of the screen from within or outside of the shower or bath when in a retracted condition or when in the extended condition.

8. A shower-screen retraction system as claimed in claim 7, further comprising a cover connectable to the housing, the cover having an open condition and a closed condition; when the screen is in a retracted condition, the further support member is abutted against the screen-mounting support member, and when the cover is in the closed condition, the cover surrounds the handle element and, at least one of: the at least one screen-contacting wiper and/or the further support member.

9. A shower-screen retraction system as claimed in claim 1, further comprising a connector having a first connector part and a second connector part engageable with the first connector part, and the second connector part is connectable to a wall via a connector-fastener.

10. A shower-screen retraction system as claimed in claim 9, wherein the second connector part comprises a hook element.

11. A shower-screen retraction system as claimed in claim 9, wherein the second connector part is slideably removably connectable to the wall via the connector-fastener.

12. A shower-screen retraction system as claimed in claim 9, wherein the first connector part is associated with the second screen end.

13. A shower-screen retraction system as claimed in claim 9, wherein the first connector part comprises a handle element.

14. A shower-screen retraction system as claimed in claim 1, wherein the screen-mounting support member is slideably engageable with a wall-mountable fastener such that the screen-mounting support member is slidably removable relative to a further wall.

15. A shower-screen retraction system as claimed in claim 14, further comprising a wall fixing element, wherein the wall fixing element is engageable with the screen-mounting support member to provide a two-part system, said two-part system being slideably engageable with the wall-mountable fastener such that the screen-mounting support member and/or the wall fixing element are slidably removable.

16. A shower-screen retraction system as claimed in claim 9, wherein the wall-mountable fastener and/or the connector-fastener comprises at least one protrusion such that the wall-mountable fastener and/or the connector-fastener is or is substantially L-shaped.

17. A shower-screen retraction system as claimed in claim 16, wherein the wall-mountable fastener and/or the connector-fastener comprises a further protrusion such that the wall-mountable fastener and/or the connector-fastener is or is substantially U-shaped.

18. A shower-screen retraction system as claimed in claim 17, the wall fixing element and/or the screen-mounting support member further comprises a recessed portion having a depth equal to or greater than a width of the said further protrusion for enabling the screen-mounting support member and/or the wall fixing element to be or substantially be flushly abuttable against the further wall.

19. A shower-screen retraction system as claimed in claim 1, wherein the housing comprises a plurality of aeration apertures and/or a mesh.

20. A method of installing a shower-screen retraction system, the method comprising the steps of: a] providing a shower-screen retraction system having a wall-mountable sliding assembly and a locking assembly; b] slideably engaging the wall-mountable sliding assembly with a first wall directly and/or indirectly via a wall fixing element and/or a fastener; c] engaging at least part of the locking assembly to a second wall via a further fastener.
